(19) United States
(12) Patent Application Publication
(10) Pub. No.: US 2010/0084823 A1
(43) Pub. Date: Apr. 8, 2010

(54) Hydraulically Balanced Radial Seal

(75) Inventor: Robert P. LaPlante, Gilford, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 12/247,595

(22) Filed: Oct. 8, 2008

(51) Int. Cl. F16J 15/48; F16J 15/32

(52) U.S. Cl. 277/552

(57) ABSTRACT

A hydraulically balanced radial seal is configured so that the hydraulic pressure of the fluid being sealed causes the primary dynamic sealing lip to be axially stretched longer and also incorporates a secondary static sealing lip whose beaded interior locks into a receiving groove in the exterior surface of the dynamic sealing lip and effects a seal between the two lips. The secondary static sealing lip being so disposed as to cause it to be compressed and shortened by the hydraulic pressure of the fluid being sealed an amount comparable to that which the primary dynamic sealing lip is being stretched under the same pressure, keeping the two lips locked together. This unique construction maintains the favorable hydraulic balance initially designed into the seal, enabling it to accommodate hydraulic pressures of over 225 psi.

### FIELD

The present disclosure relates to hydraulically balanced high pressure radial seals.

### BACKGROUND

This section provides background information related to the present disclosure which is not necessarily prior art.

Radial seals that allow the pressure of the medium being sealed to act against the seal lip, cause very high loads at the junction of the sealing lip and shaft, resulting in premature failure of the seal due to excessive friction, heat, and wear. Attempts at improving these seals, such as improving the thickness of the flex section and decreasing its length, using a stiffer seal lip material, or using a rigid backing sleeve between the inside surface of the seal lip and shaft, limit the ability of the seal to accommodate shaft to bore misalignment and dynamic shaft eccentricity, shortening the life of the seal.

U.S. Pat. No. 3,443,814 discloses a hydraulically balanced radial seal that provides a seal design that is superior to prior art seals not employing a garter spring or other form of spring in terms of handling increased pressures at higher velocities, but still has relatively limited hydraulic pressure accommodation capability due to the fact that the axial location of the O-ring secondary seal, and the rigid wall of the case against which the O-ring abuts and seals are relatively fixed in their axial position. The rubber dynamic sealing lip is relatively free to be axially compressed shorter by the hydraulic pressure to be sealed from the right of U.S. Pat. No. 3,443,814, as shown in FIG. 2 of the patent. This alters and disturbs the hydraulic balance initially provided in design, effectively limiting the design to sealing hydraulic pressures under 100 psi. Accordingly, it is desirable to provide an improved hydraulically balanced radial seal that is capable of sealing hydraulic pressures in excess of these prior seal designs.

### SUMMARY

This section provides a general summary of the disclosure, and is not a comprehensive disclosure of its full scope or all of its features.

The present disclosure provides a hydraulically balanced radial seal that is configured so that the hydraulic pressure of the fluid being sealed causes the primary dynamic sealing lip to be axially stretched longer and also incorporates a secondary static sealing lip whose beaded interior locks into a receiving groove in the exterior surface of the dynamic sealing lip and effects a seal between the two lips. The secondary static sealing lip is so disposed as to cause it to be compressed and shortened by the hydraulic pressure of the fluid being sealed an amount comparable to that which the primary dynamic sealing lip is being stretched under the same pressure, keeping the two lips locked together. This unique construction maintains the favorable hydraulic balance initially designed into the seal, enabling it to accommodate hydraulic pressures of over 225 psi.

According to one aspect of the present disclosure, a hydraulically balanced radial seal for shaft to bore sealing is provided with an outer case having a rubber covered outer surface adapted to sealingly engage the bore, and an attached static sealing lip for locking into a dynamic sealing lip of the seal assembly. A dynamic seal including a seal lip is adapted to engage the shaft and is supported by a rigid insert that is received by the outer case. The dynamic seal includes a receiving groove on an exterior surface of the seal lip for receiving the static sealing lip therein. A vent passage is disposed between the outer case and the seal insert for communicating pressurized medium to the static sealing lip.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional view of a hydraulically balanced radial seal according to the principles of the present disclosure; and

FIG. 2 is a cross-sectional view of an alternative hydraulically balanced radial seal according to the principles of the present disclosure.

Corresponding reference numerals indicate corresponding parts throughout the several views of the drawings.

### DETAILED DESCRIPTION

Example embodiments will now be described more fully with reference to the accompanying drawings.

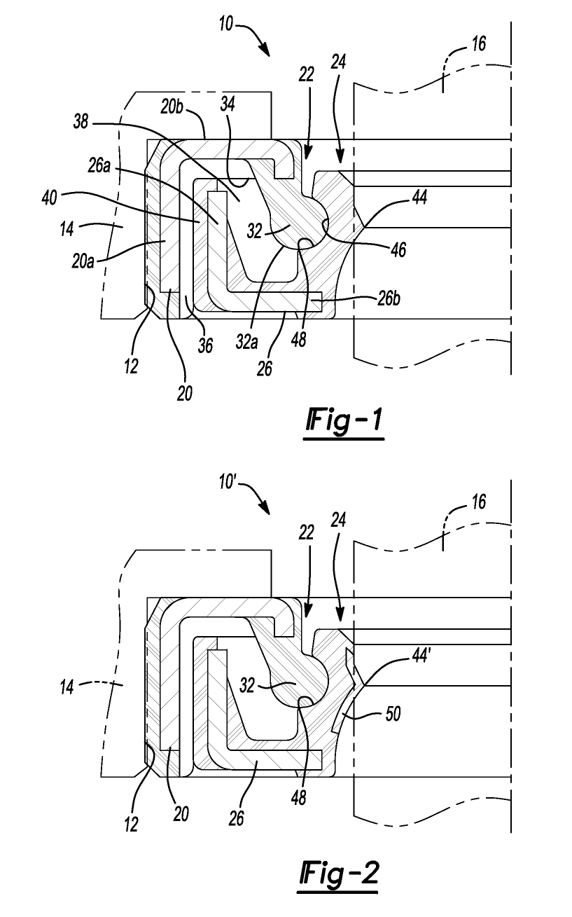

With reference to FIG. 1, a hydraulically balanced radial seal 10, according to the principles of the present disclosure, will now be described. The radial seal 10 is designed to be received in a bore 12 of a housing 14 and engages a shaft 16. The seal 10 includes a case 20 supporting a static seal 22 and dynamic seal 24 that is supported by a seal insert 26. The case 20 can include an axially extending portion 20a and a radially inwardly extending portion 20b extending from an end of the axially extending portion 20a. The axially extending portion 20a can be overmolded with an elastomer that provides a friction fit with the bore 12 of the housing 14.

The static seal 22 can be molded to the radial portion 20b of the case 20 at a radially inner end thereof. The static seal can include a beaded interior 32 that extends axially toward the liquid or high pressure side of the seal 10. The beaded interior 32 of the static seal has an end face portion 32a. The case 20 can include elastomeric material 34 on an interior surface of the axial portion 20a that can be provided with vent grooves 36 that allow pressurized medium to enter a chamber 38 disposed between the case 20 and seal insert 26.

The seal insert 26 can be separately formed and attached to the case 20 or integrally attached thereto. In the case of a separately formed insert, the seal insert 26 can be provided with elastomeric material 40 on an exterior surface thereof for engagement with the elastomeric material 34 on the interior of the case 20. The elastomeric material 40 or the seal insert 26 can also be provided with vent grooves or passages in addition to, or as an alternative to, the vent grooves 36 provided in the elastomeric material 34 on the interior of the case 20. The elimination of the elastomeric material 34 or 40 is also contemplated by this disclosure so long as vent passages are provided for communication to the chamber 34 therebetween. The seal insert 26 can include an axially extending portion 26a which is generally concentric with the axial portion 20a of the case 20 and can include a radially inwardly extending portion 26b extending from an end of the axially extending portion 26a opposite to the radially extending portion 20b of the case 20. The dynamic seal 24 extends axially from an inner end of the radially inwardly extending portion 26b and includes a dynamic sealing lip 44 that engages the shaft 16. A receiving groove 46 is disposed on an exterior surface of the dynamic seal 24 and receives the beaded interior 32 of the static seal 22 therein. The receiving groove 46 can include a shoulder portion 48 disposed against an end face 32a of the static seal 22.

In operation, the hydraulic pressure of the fluid being sealed causes the dynamic seal 24 to be axially stretched longer and also incorporates the secondary static sealing lip 22 whose beaded interior 32 locks into the receiving groove 46 in the exterior surface of the dynamic seal lip 44 and effects a seal between the dynamic seal 24 and static seal 22. The secondary static sealing lip 22 is so disposed as to cause it to become compressed and shortened by the hydraulic pressure of the fluid being sealed an amount comparable to that which the primary dynamic sealing lip is being stretched under the same pressure, keeping the two lips 22, 44 locked together. The pressurized fluid being sealed enters into the chamber 38 between the case 20 and seal insert 26 and acts inwardly on both the secondary static sealing lip 22 and the primary dynamic sealing lip 44. The pressure also enters the interior of the primary dynamic sealing lip 44 and acts outwardly on the lip, thus, offsetting, canceling, or balancing to a large extent the hydraulic pressure acting inwardly on the lips. This hydraulic balancing is what enables the seals 22, 24 to withstand much higher pressures than more conventional seal constructions which do not provide a means of either restricting pressures from acting upon the entire dynamic sealing lip or by providing means of essentially equalizing the pressure acting on the exterior and interior surfaces of the dynamic sealing lip. The seal of the present disclosure enables it to accommodate hydraulic pressures of over 225 psi which is more than double the hydraulic pressure of the prior art design of U.S. Pat. No. 3,443,814.

With reference to FIG. 2, an alternative hydraulically balanced radial seal 10′ is shown which is virtually identical to the seal 10 shown in FIG. 1, except the interior of the dynamic sealing lip 44′ has a thin PTFE liner 50 to reduce friction with the rotating shaft 16. The design of the present disclosure provides more reliable performance than existing hydraulically balanced radial seal designs at only a fraction of the cost of the designs such as those disclosed in U.S. Pat. No. 3,443,814.

The improved hydraulically balanced radial seal design of the present disclosure effectively at least doubles the hydraulic pressure handling capability of known prior art designs. These improved designs also eliminate outer case roll-closing and centerless grinding, secondary and inner case hole piercing operations inherent in the prior art design for reducing manufacturing cost in comparison thereto. This improved design also features a rubber covered seal assembly outer diameter for more reliable sealing in rougher or larger tolerance housing bores, and/or for press fitting and holding the seal assembly in softer and higher thermal expansion bores such as plastic or aluminum rather than steel. These advantages individually and in total significantly expand the application potentials and cost competitiveness of the improved designs compared to the prior art designs. One potential application for these seal designs is for high pressure (greater than 200 psi) high rotation of velocity (i.e., 40 FPS) capable designs such as in a hydraulic hybrid regenerative braking system intended for use in frequent start/stop vehicles such as refuse trucks and postal delivery vehicles.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A hydraulically balanced radial seal for shaft to bore sealing, comprising:
a case having an outer surface adapted to sealingly engage the bore and a static seal attached to said case;
a dynamic seal including a seal lip adapted to engage the shaft and supported by a seal insert attached to said case, said dynamic seal including a receiving groove on an exterior surface of said seal lip for receiving said static seal therein;
a vent passage disposed between said case and said seal insert for communicating pressurized medium to said static seal.

2. The hydraulically balanced radial seal according to claim 1, wherein said recessed groove has an arcuate cross-section.

3. The hydraulically balanced radial seal according to claim 2, wherein said static seal has an arcuate cross-section.

4. The hydraulically balanced radial seal according to claim 1, wherein said sealing lip extends axially from said seal insert in a first direction and said static seal extends axially from said case in a second axial direction opposite to said first direction.

5. The hydraulically balanced radial seal according to claim 1, wherein said case includes an axially extending portion having an elastomeric material on an interior surface thereof and including at least one groove therein defining said vent passage.

6. The hydraulically balanced radial seal according to claim 1, wherein said case includes an axially extending portion and a radially inwardly extending portion, said static seal extending axially from said radially inwardly extending portion.

7. The hydraulically balanced radial seal according to claim 6, wherein said seal insert includes an axially extending insert portion that is concentric with said axially extending portion of said case and a radially inwardly extending insert portion supporting said dynamic seal and spaced from said radially inwardly extending portion of said case.

8. The hydraulically balanced radial seal according to claim 1, wherein said static seal is molded to said case.

9. A hydraulically balanced radial seal for shaft to bore sealing, comprising:
a case having an outer surface adapted to sealing engage the bore and a static seal attached to said case;
a dynamic seal including a seal lip adapted to engage the shaft and supported by a seal insert attached to said case, said static seal engaging an exterior surface of said dynamic seal;
said seal insert and said case defining a chamber therebetween and a vent passage communicating with said chamber for communicating pressurized medium to force said static seal against said dynamic seal.

10. The hydraulically balanced radial seal according to claim 9, wherein said exterior surface of said dynamic seal includes a recessed groove having an arcuate cross-section.

11. The hydraulically balanced radial seal according to claim 10, wherein said static seal is received in said recessed groove and has an arcuate cross-section.

12. The hydraulically balanced radial seal according to claim 9, wherein said sealing lip extends axially from said seal insert in a first direction and said static seal extends axially from said case in a second axial direction opposite to said first direction.

13. The hydraulically balanced radial seal according to claim 9, wherein said case includes an axially extending portion having an elastomeric material on an interior surface thereof and including at least one groove therein defining said vent passage.

14. The hydraulically balanced radial seal according to claim 9, wherein said case includes an axially extending portion and a radially inwardly extending portion, said static seal extending axially from said radially inwardly extending portion.

15. The hydraulically balanced radial seal according to claim 14, wherein said seal insert includes an axially extending insert portion that is concentric with said axially extending portion of said case and a radially inwardly extending insert portion supporting said dynamic seal and spaced from said radially inwardly extending portion of said case.

16. The hydraulically balanced radial seal according to claim 9, wherein said static seal is molded to said case.
